(19) United States
(12) Patent Application Publication
(10) Pub. No.: US 2020/0066070 A1
(43) Pub. Date: Feb. 27, 2020

(54) IMPROVEMENTS RELATING TO HEARING ASSISTANCE IN VEHICLES

(71) Applicant: JAGUAR LAND ROVER LIMITED, COVENTRY, WARWICKSHIRE (GB)

(72) Inventor: ANDREW WELLS, Warwickshire (GB)

(21) Appl. No.: 16/349,911

(22) PCT Filed: Nov. 1, 2017
(86) PCT No.: PCT/EP17/77978

§ 371 Date: May 14, 2019

(30) Foreign Application Priority Data
Nov. 29, 2016 (GB) 1620114.7
Nov. 29, 2016 (GB) 1620115.4

(51) Int. Cl. G07C 5/08; G07C 5/02; B60W 50/14; B60L 58/12; G05D 1/00; G05D 1/02; H04R 25/00

(52) U.S. Cl. CPC G07C 5/0833; G07C 5/02; B60W 50/14; H04R 25/554; G05D 1/0088; G05D 1/0223; B60L 58/12

(57) ABSTRACT

A system (14) for a vehicle (10) for providing improved audio for a hearing impaired user, the system (14) comprising an input configured to receive electrical input signals from at least one vehicle mounted device (22), wherein the electrical input signals are representative of an operative state of the vehicle (10). The system (14) further comprises a processor (30) configured to compare the electrical input signals with a predefined criterion to determine a comparison. The system (14) is configured to generate electrical output signals corresponding to audio in dependence on the comparison and to transmit the electrical output signals to an audio output device for outputting the audio to the user.

There is therefore a need to provide greater accessibility for hearing-impaired vehicle users, especially when considering important information that is communicated audibly.

At least in certain embodiments, the present invention seeks to mitigate or overcome at least some of the above-mentioned problems.

### SUMMARY OF THE INVENTION

Aspects and embodiments of the invention provide a system, a method, a processor, a media device storing computer readable code and a vehicle as claimed in the appended claims.

According to an aspect of the present invention there is provided a system for a vehicle for providing improved audio for a hearing impaired user, the system comprising: an input configured to receive electrical input signals from at least one vehicle mounted device, wherein the electrical input signals are representative of an operative state of the vehicle; and a processor configured to compare the electrical input signals with a predefined criterion to determine a comparison; the system being configured to generate electrical output signals corresponding to audio in dependence on the comparison and to transmit the electrical output signals to an audio output device for outputting the audio to the user.

Advantageously, the system ensures that alerts or other output signals are sufficiently communicated to hearing impaired users without interference that may otherwise be present if the system were not used. In allowing a signal to be transmitted to the audio output device in this way, the system improves the experience for the user, as well as for the other vehicle occupants. In addition, the system provides a beneficial clarity, variability, and increased simplicity of use for the hearing impaired user by ensuring that any signal that needs to be communicated to the user is communicated via a single pathway through the audio output device.

The system may comprise an exchange module configured to transmit the electrical output signals to the audio output device. The exchange module may be wireless enabled so as to permit wireless communication with the audio output device, in use. For example, wireless enablement may take the form of a short-range radio frequency communication technology such as Bluetooth®. In one embodiment of the invention, the exchange module may communicate with the audio output device via a mobile device. In one embodiment, the audio output device may comprise a mobile device. In other embodiments, the audio output device optionally comprises a hearing assistance device.

Enabling wireless communication with an audio output device increases the ease of use for hearing impaired users and increases the range of hearing impairments for which the system may be used. For example, by enabling wireless communication with a hearing assistance device, or more generally a ‘hearing aid’, users with particularly severe hearing impairments will be able to clearly understand the audio which they may not have previously understood if the audio had come from a typical vehicle audio system such as a single speaker disposed in the dashboard of the vehicle. The system offers users a particularly useful alternative to simply increasing the volume of vehicle loudspeakers, which may lead to distortion of the signal or to discomfort in non-hearing-impaired users who may use the vehicle at the same time.

The processor may be configured to communicate with the exchange module. Optionally, the exchange module is in electrical communication with the processor via an amplifier.

The electrical input signals may include electric signals received from a sensor system configured to indicate a vehicle operation, a vehicle status, a vehicle system malfunction, and/or a vehicle component malfunction.

The processor may be configured to compare the electrical input signals received from a sensor measuring vehicle speed with a predetermined criterion in the form of a predetermined speed threshold, and may also be configured to generate the electrical output signals in dependence on the predetermined speed threshold being exceeded.

The processor may be configured to compare the electrical input signals received from a fuel level sensor with a predetermined threshold fuel level regarded as a minimum acceptable fuel level. The processor is optionally configured to generate the electrical output signals in dependence on the fuel level falling below the predetermined threshold fuel level.

The processor may be configured to transmit repeatedly the electrical output signals if a threshold continues to be exceeded.

Communicating speed threshold exceedances and fuel level drops to the user is particularly useful to the user if the user is driving the vehicle. These alerts often have a short duration and so it is likely that a hearing impaired user may not ordinarily register the output. By configuring the processor to generate electrical output signals, the system can be altered to ensure that the user is able to register the output signal and act accordingly.

In an embodiment, the processor may be configured to compare the electrical input signals received from a charge sensor associated with a rechargeable electrical storage system (for example, in an electric vehicle or in a hybrid electric vehicle) with a predetermined threshold charge level regarded as a minimum acceptable charge level, and may be configured to generate the electrical output signals in dependence on the charge level falling below the predetermined threshold charge level. This is particularly beneficial in an electric vehicle where it is desirable to warn the user when the level of charge falls below a minimum acceptable level.

The processor may be configured to compare the electrical signals with a criterion to indicate that a direction indicator is on and, if it is determined that the direction indicator is on based on the comparison, to generate the electrical output signals.

Optionally, the vehicle may be operable in an autonomous mode and the processor may be configured to compare the electrical signals with a criterion to indicate malfunction of a component related to the autonomous mode and, if it is determined that the component has malfunctioned based on the comparison to generate the electrical output signals.

The processor may be configured to compare the electrical input signals received from a sensor measuring engine speed with a predetermined criterion in the form of a predetermined engine speed threshold, and may also be configured to generate the electrical output signals in dependence on the predetermined engine speed threshold being exceeded.

The processor may be configured to compare the electrical input signals received from a sensor measuring engine speed with a plurality of predetermined criteria in the form of predetermined engine speed thresholds, and may also be configured to generate the electrical output signals in dependence on the predetermined engine speed thresholds being exceeded. The electrical output signals may correspond to a vehicle engine noise.

The processor may be configured to compare the electrical input signals with a criterion to indicate that a user is seated on a seat and whether a seat belt is in use for that seat, and if it is determined that the seat belt is not being used based on the comparison, the processor may be configured to generate the electrical output signals.

The processor may be configured to compare the electrical input signals received from a sensor measuring distance of the vehicle to a surface with a predetermined criterion in the form of a predetermined distance threshold regarded as a minimum acceptable distance to the surface, and the processor may also be configured to generate the electrical output signals in dependence on the distance falling below the predetermined distance threshold. In this manner the processor generates the electrical output signals in dependence on the vehicle being in close proximity to the surface (i.e. closer to the surface than the predetermined distance threshold).

The vehicle mounted device may comprise a microphone.

The system may comprise a further input to receive an occupancy signal to indicate that the user is external to the vehicle. The system may be further configured to generate an electrical output signal in dependence on the occupancy signal.

The system may be configured to determine a distance of the user from the vehicle. The system may be configured to generate an electrical output signal in dependence on the distance being less than a predetermined distance from the vehicle. The electrical output signal may comprise a vehicle alarm signal, an output signal that the vehicle is unlocked or locked or an output signal to indicate that the vehicle's headlights are on.

According to another aspect of the invention, there is provided a system for a vehicle comprising a zone and a microphone associated with the zone, the system being configured to provide improved audio for a hearing impaired user of the vehicle, the system comprising: a first input configured to receive electrical input signals from the microphone corresponding to sound within the zone; and a second input configured to receive a signal indicative of an occupant being within the zone; the system being configured to generate electrical output signals corresponding to the electrical input signals received from the microphone and to transmit the electrical output signals to an audio output device for outputting audio to the user.

It is particularly important for vehicle users to not only receive vehicle-generated audio but also to be aware of other occupants of the vehicle and sounds they make. Vehicle interiors are particularly noisy and so vehicle users with hearing impairments may have difficulty in selectively filtering occupant speech from general ambient noise. Therefore, it is particularly beneficial to a hearing impaired user to be assisted by the system with regard to occupant conversation, and for reinforcement of the signal to be transmitted to the audio output device.

The system may comprise a user input module configured to enable selection of the zone by the user to identify the presence of an occupant within the zone for input to the second input. The system may comprise a seat identification system for identifying the presence of an occupant with the zone automatically for input to the second input.

According to another aspect of the present invention, there is provided a system for a vehicle for providing improved audio for a hearing impaired user, the system comprising: a first input configured to receive electrical input signals from at least one vehicle mounted device; and a second input configured to receive a signal to indicate that a hearing assistance device is present within the vehicle; the system being configured to generate electrical output signals corresponding to audio and to transmit the electrical output signals to the hearing assistance device for outputting the audio to the user in dependence on a signal being received at the second input.

In practice, the system advantageously allows for differentiation between hearing assistance devices and other vehicle audio output devices, thereby allowing a hearing impaired user to receive information specific to their role in the vehicle's operation.

The signal received at the second input may be a wireless signal and the second input may be a user input interface. The user input interface may be a human-machine interface, and may be mounted within the vehicle or may be a mobile device.

The vehicle mounted device may comprise a satellite navigation system or an infotainment system. In this case, the system may be further configured to generate electrical output signals comprising audio content from the satellite navigation system and/or the infotainment system.

According to another aspect of the invention, there is provided a vehicle that comprises the system as described above.

Optionally, the vehicle comprises at least one loudspeaker and at least one seat having a head rest, said at least one loudspeaker being arranged within the head rest of the at least one seat and wherein the system is configured to transmit electrical output signals to said at least one loudspeaker. The electrical output signal may be generated such that conversion of the signal to audio causes destructive interference at the head rest speaker, thereby lowering the level of ambient noise within the vehicle.

Head rest loudspeakers allow seat specific reinforcement of the intended sound, or destructive interference causing a decrease in ambient noise, which beneficially improves the signal-to-noise ratio of the sound communicated to the hearing impaired user.

In certain embodiments, the one or more headrest loudspeakers may be controlled in combination with a hearing assistance device present within the vehicle. By way of specific example, a user may have a hearing impairment in both left and right ears although the impairment may not be the same in both ears. For example, the severity of the hearing impairment may worse in one ear than the other, necessitating use of a hearing assistance device in only one ear (say the left ear). In this case, electrical output signals corresponding to audio may be modified to attenuate or mute the audio level prior to outputting to the headrest speaker adjacent the user's ear in which the hearing assistance device is worn (the left ear in this example). This may improve the intelligibility of the audio for the user. In addition, electrical output signals corresponding to audio may be modified to amplify or increase the audio level prior to outputting to the headrest speaker adjacent the user's un-assisted ear (the right ear in this example).

The vehicle may comprise an autonomous driving control module, and the system may be further configured to generate electrical output signals in dependence on a manual operation request from the autonomous driving control module.

According to another aspect of the invention, there is provided a method of providing improved audio for a hearing impaired user in a vehicle, the method comprising:

receiving electrical input signals from at least one vehicle mounted device, wherein the electrical input signals are representative of an operative state of the vehicle; comparing the electrical input signals with a predefined criterion to determine a comparison; generating electrical output signals corresponding to audio in dependence on the comparison; and transmitting the electrical output signals to an audio output device for outputting the audio to the user.

According to another aspect of the invention, there is provided a media device storing computer program code adapted, when loaded into or run on a computer or processor, to cause the computer or processor to become the system as described above

According to another aspect of the invention, there is provided a media device storing computer program code adapted, when loaded into or run on a computer or processor, to cause the computer or processor to perform the method as described above.

The media device described in the above aspects may comprise a non-transitory computer readable media.

According to another aspect of the present invention there is provided a system for a vehicle for providing improved audio for a hearing impaired user, the system comprising: an input configured to receive electrical input signals from at least one vehicle mounted device, wherein the electrical input signals are representative of an operative state of the vehicle; a user input module configured to enable user input of at least one user characteristic; and a processor configured to generate electrical output signals corresponding to audio and to transmit the electrical output signals to at least one audio output device for outputting the audio to the user, wherein the generation of the electrical output signals is dependent upon the at least one user characteristic.

Advantageously, the system ensures clear communication of vehicle alerts to hearing impaired users according to their specific preference and needs. A user input module allows for information particular to a user to be input to the system. The user characteristic is easily variable and allows for personalised signals to be transmitted to audio devices within a vehicle. The signals are particularly tailored to the user's needs or wishes, which means that the user experience in the vehicle can be improved significantly and that signals are communicated most efficiently and intelligibly.

The processor may be configured to determine the hearing impairment level, and optionally determines the hearing impairment level automatically. The processor may be arranged to determine the hearing impairment level by conducting an overt or covert audiometric test to provide an audiogram indicative of the user's hearing acuity and/or impairment. Optionally, the processor is configured to conduct an audiometric test using otoacoustic emission tracking (OAE). This further benefits the user and enhances the user experience.

The user input module may be configured to enable user input of a hearing impairment level for the user.

The hearing impairment level may comprise a first hearing impairment level and a second hearing impairment level corresponding to a left ear and a right ear of the user, respectively.

The processor may be configured to generate electrical output signals in dependence on the hearing impairment level or in dependence upon the user characteristic.

The user input module may be configured to enable user selection of the at least one audio output device.

Optionally, the processor is configured to transmit the electrical output signals to a hearing assistance device and/or a loudspeaker. The processor may be configured to transmit the electrical output signals to at least two hearing assistance devices and/or at least two loudspeakers. This advantageously caters for all hearing impaired users, ensuring that the system can be used by all those who require assistance.

In some embodiments, the user input module may be configured to enable user selection of a zone for the hearing impaired user, and wherein the system is configured to transmit electrical output signals in dependence on the selected zone. Additionally, the user input module may be configured to enable user selection of a zone for a passenger within the vehicle, and wherein the processor is configured to transmit electrical output signals corresponding to signals received from a microphone associated with the selected zone. Selecting zones is particularly important in allowing the user to hear requested sounds from anywhere within the vehicle. In one example, the or each zone may relate to a seating position or a seat of a user of the vehicle.

The user characteristic may relate to at least one characteristic or feature of the electrical output signal, and the feature may comprise a waveform, an amplitude, or frequency content of the electrical output signal. Allowing variability of the features of the electrical output signal further allows for an improved user experience, as well as further catering for differing hearing impairments. For example, if a hearing impairment is particular to a certain band of frequencies, a different frequency content of the output signal may be required to enable the signal to be heard by the user.

The user input module may comprise an infotainment system. In this case, the system may be further configured to generate electrical output signals comprising audio content from the infotainment system.

According to another aspect of the invention, there is provided a vehicle comprising the above system.

According to another aspect of the invention, there is provided a processor for use in the system as described herein before, or for use in the vehicle as described in the foregoing aspect.

According to another aspect of the invention, there is provided a method of providing improved audio for a hearing impaired user in a vehicle, the method comprising: receiving from at least one vehicle mounted device electrical signals representative of an operative state of the vehicle; receiving from a user input module electrical signals representative of at least one user characteristic; processing the received electrical signals representative of the operative state of the vehicle in dependence on the received electrical signals representative of the at least one user characteristic; generating electrical output signals corresponding to audio in dependence on said processed electrical signals; transmitting the electrical output signals to at least one audio output device for outputting the audio to the user.

According to yet another aspect of the invention, there is provided media device storing computer program code adapted, when loaded into or run on a computer or processor, to cause the computer or processor to become a system as described in one or more of the foregoing aspects.

According to a further aspect of the invention, there is provided a media device storing computer program code adapted, when loaded into or run on a computer or processor, to cause the computer or processor to perform the method as described above.

The media device described in the above aspects may comprise a non-transitory computer readable media.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is schematic diagram of a vehicle having a vehicle interior provided with a hearing assistance system according to an embodiment of the invention;

FIG. 2 is a schematic block diagram of a hearing assistance system that may be installed in the vehicle of FIG. 1;

FIG. 3 is a flow chart illustrating operation of the hearing assistance system of FIG. 2;

FIG. 4 is a flow chart illustrating initiation of the hearing assistance system of FIG. 2; and

FIGS. 5 to 7 illustrate example displays for a human-machine interface that forms part of the hearing assistance system of FIG. 2.

### DETAILED DESCRIPTION

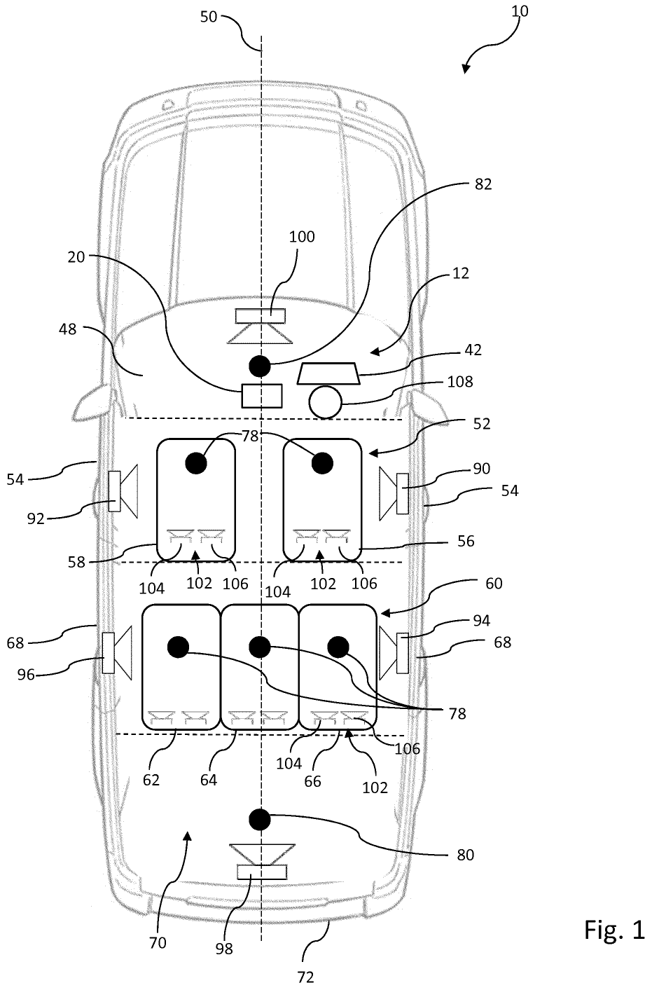

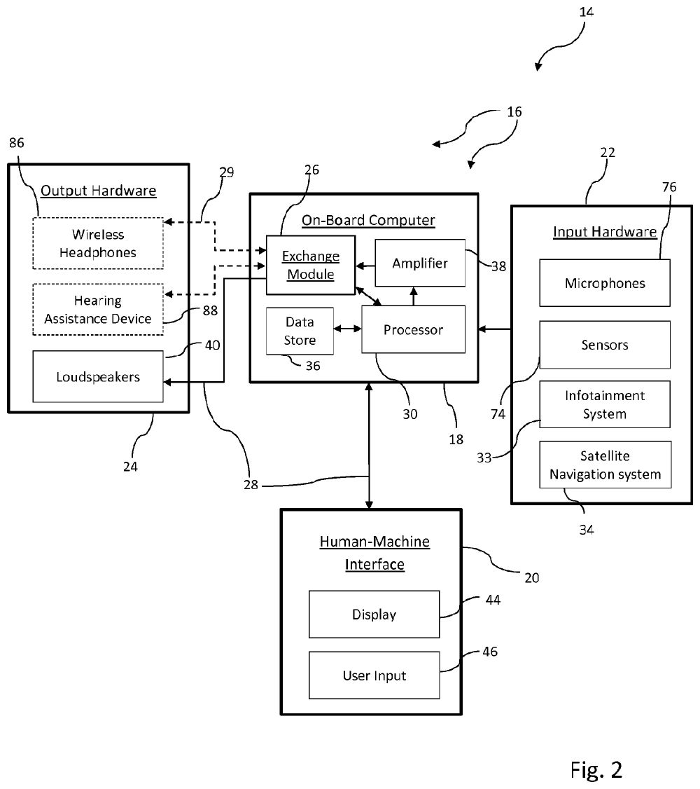

FIG. 1 is a schematic diagram of a vehicle 10 having a vehicle interior 12 provided with a hearing assistance system according to an embodiment of the invention. The hearing assistance system 14, which is shown in FIG. 2, improves user experience and accessibility options available to a user of the vehicle 10 by allowing users with hearing impairments to implement audio settings tailored to their requirements. More specifically, the system 14 ensures that audio signals can be communicated to hearing impaired users who wear a hearing assistance device quickly and clearly by directly transmitting warning signals or other sounds to the hearing assistance device.

For the purposes of this application, it should be assumed that any reference to a hearing assistance device includes medical devices used for improvement of hearing of users with hearing impairments, such as a wireless hearing aids, as well as wireless headphones such as the type used with portable audio devices.

Considering both FIGS. 1 and 2, the vehicle 10 incorporates a hearing assistance system 14, comprising a plurality of modules 16 including on-board computer 18 that is electrically connected to a user input module comprising a human-machine interface (HMI) 20, input hardware 22, output hardware 24 and an exchange module 26.

The connections 28 between modules 16 and the directions of travel of information between these modules 16 are indicated in FIG. 2 by arrows. Connections 29 that may not require physical connections are illustrated using a dashed line. It will be noted that FIG. 2 is a schematic view, so the way in which the commands are transferred between modules 16 or hardware is not depicted explicitly. However, it will be appreciated that suitable cabling may be provided to interconnect the modules 16, and that these interconnections may be direct or ‘point to point’ connections, or may be part of a local area network (LAN) operated under a suitable protocol (CAN-bus or Ethernet for example). Vehicle bus communications networks form part of the art and will not be discussed in detail in this application.

It should also be noted that the output hardware modules 86, 88 that are outlined using a dashed line are not considered to be part of the hearing assistance system 14 as it is manufactured and/or sold. Similarly, it should be noted that the sensors and microphones may be separate from the system and information may be received from the sensors by the system.

The on-board computer 18 implements commands according to pre-defined user instructions. The commands alter various settings of the hearing assistance system 14, and are implemented in response to data inputs received in the form of electrical input signals at a processor 30. The commands comprise electrical output signals that are generated at the on-board computer 18 based upon the input signals.

More specifically, the on-board computer 18 receives input signals from the HMI 20 or from the input hardware 22. Within the on-board computer 18, a processor 30 may receive input signals from an exchange module 26 or may request and receive information from a data storage memory 36. Similarly, within the on-board computer 18, the processor 30 generates output signals that are sent to an amplifier 38 for amplification of the output signal, to the exchange module 26 either directly or via the amplifier 38, or written to the data storage memory 36 for later recall. The on-board computer 18 provides output signals and/or commands to the HMI 20.

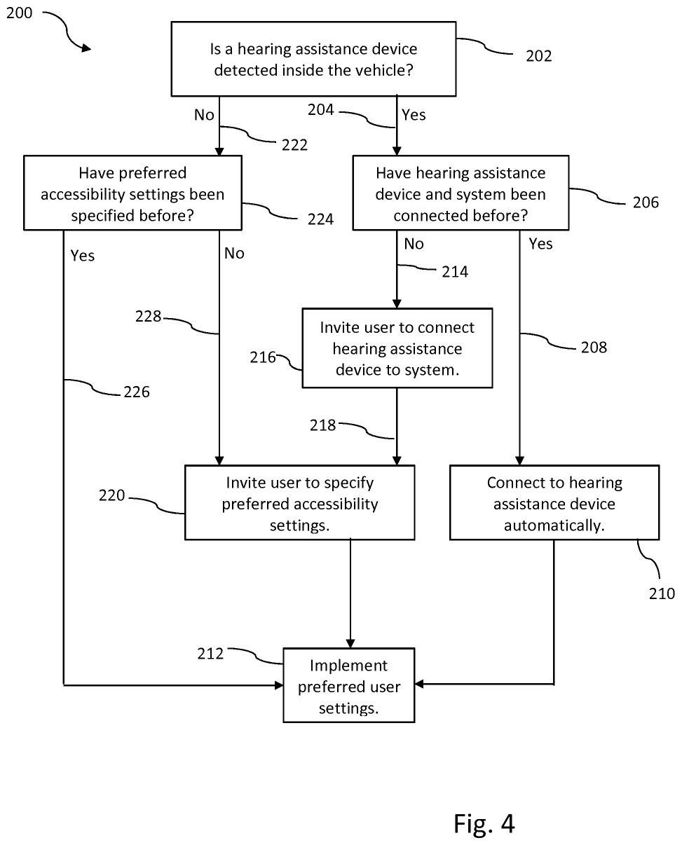

The HMI 20 comprises a display screen 44 and a user input interface 46. Via the HMI 20, information can be presented to a user on the display screen 44 and the user can instruct the operation of the processor 30, and thus influence the operation of the hearing assistance system 14, using the user input interface 46. The user input interface 46 may be provided, for example, in the form of a physical keyboard or as a touch-sensitive screen being part of the display 44. In use, the HMI 20 allows the user to input information relating to their hearing impairment to tailor the operation of the system 14 accordingly as will be discussed in more detail later in relation to FIG. 4.

Still considering FIGS. 1 and 2, the HMI 20 is located centrally in a dashboard 48 of the vehicle 10 along a central axis 50 of the vehicle 10 so that it is within reach of a user seated in a first seating row 52 of the vehicle 10. The first seating row 52 is roughly aligned with a front pair of doors 54 of the vehicle 10, and comprises a driver's seat 56 and a passenger's seat 58. A second seating row 60 including three seats 62, 64, 66 roughly aligned with a rear pair of doors 68, is spaced from the first seating row 52, and the interior 12 further includes a luggage space 70 disposed between the second seating row 60 and a tailgate 72.

As mentioned above, input signals are received by the processor 30 from input hardware 22. The input hardware 22 comprises one or more of a plurality of vehicle mounted devices such as a satellite navigation system 34, an infotainment system 33, a plurality of sensors 74 and a plurality of microphones 76. In alternative embodiments the satellite navigation and infotainment systems 34, 33 may be incorporated into the on-board computer 18 or may be external to the system 14, such as within a mobile phone or other portable device.

In practice, a sensor may comprise a single sensing element or a plurality of sensing elements configured to measure a parameter. The plurality of sensors 74 are configured to take measurements relating to operational parameters or operative states of the vehicle 10. The sensors 74 are configured to send an electrical input signal or signals representative of each measurement to the processor 30. Typical examples of sensors 74 are speedometers, tachometers, indicator sensors that sense the current status of the indicator (i.e. on or off), and fuel level sensors or gauges. In one embodiment, an operative state of the vehicle 10 measured by a speedometer is considered to be an instantaneous speed measurement, or may be an average speed of the vehicle 10. An operative state of the vehicle 10 may also be monitored using more than one reading of particular parameters, or readings of more than one parameter at a particular instance.

The microphones 76 are dispersed within the interior 12 of the vehicle 10 and detect sound within the interior 12, being optimally positioned within the vehicle interior 12 to ensure adequate coverage of the volume of the interior 12. Some or all of the microphones 76 may be arranged into one or more microphone arrays, with an array comprising at least two microphones positioned close to a predetermined position. A microphone or microphone array 78 is positioned above each seat 56, 58, 62, 64, 66 to specifically pick up sound in the vicinity of that seat 56, 58, 62, 64, 66 in the interior 12 of the vehicle 10. At least two microphones 80, 82 are placed to register ambient sound within the interior 12 of the vehicle 10; in this case one is located above the dashboard 48 and one is located above the luggage space 70.

The processor 30 is in communication with the exchange module 26, either directly or via the amplifier 38. The exchange module 26 is capable of detecting, distinguishing between and communicating with, audio output hardware including headphones 86 or hearing assistance devices 88. It is envisaged that this hardware 86, 88 is enabled for wireless communication and connects or ‘pairs’ with the exchange module 26 using a wireless communication technology such as a suitable Bluetooth protocol. However, it would be possible to implement the system 14 using a physical connection between the listed output hardware 86, 88 and the exchange module 26 without departing from the scope of the invention.

It is depicted here that the exchange module 26 is incorporated within the on-board computer 18. However, the exchange module 26 and the on-board computer 18 may be separate modules. Additionally, the amplifier 38 may be separate from the on-board computer 18. Alternatively, the exchange module 26 or amplifier 38 may form part of the processor 30.

The exchange module 26 is capable of transmitting electrical signals corresponding to audio to the audio output hardware 86, 88, 40, where it is converted to an audio signal. For example, the exchange module 26 is capable of transmitting audio signals to a plurality of loudspeaker arrays dispersed throughout the vehicle 10. The term loudspeaker array may refer to a plurality of loudspeakers 40 of differing sizes, typically a trio of woofer, tweeter and sub-woofer, or to a single loudspeaker.

As shown in FIG. 1, a pair of loudspeaker arrays 90, 92 is disposed in the front pair of doors 54 of the vehicle 10 and a pair of loudspeaker arrays 94, 96 is disposed in the rear pair of doors 56 of the vehicle 10. Each pair of loudspeaker arrays 90, 92 and 94, 96, flanks a respective seating row 52, 60. At least one loudspeaker array 98 is disposed in the luggage space 70 and at least one loudspeaker array 100 is disposed at the front end of the vehicle 10 in the vicinity of the dashboard 48.

In addition to these more general loudspeaker arrays, seat-specific arrays 102 are incorporated into headrests of the seats 56, 58, 62, 64, 66. These arrays 102 are each formed of two small loudspeakers 104, 106 disposed in the headrest of their respective seat 56, 58, 62, 64, 66 so that when a user is seated at least one loudspeaker 104, 106 is directed towards each of the user's ear.

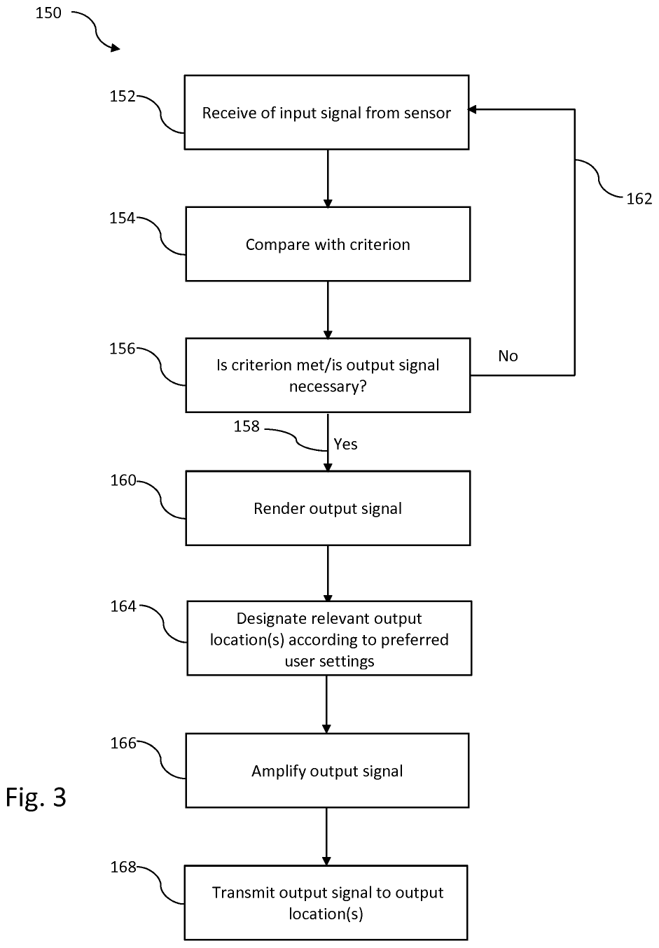

In operation, the system 14 operates according to the process 150 shown in FIG. 3. For simplicity, the process 150 of FIG. 3 is described only with reference to a system 14 having a single sensor. In practice, it is expected that the system 14 will comprise a plurality of sensors 74 and that the on-board computer 18 will receive multiple input signals simultaneously, all of which are processed according to the process 150 shown in FIG. 3.

Initially, at step 152, an electrical input signal is received by the on-board computer 18 from a sensor, for example a speedometer measuring vehicle speed. The input signal received by the on-board computer 18 is analysed at the processor 30, and the information gathered by the analysis is compared with a respective criterion stored in the memory 36 of the on-board computer 18 at step 154. For example, for a speedometer sensor, the sensor sends input signals to the on-board computer 18 that are indicative of the instantaneous speed of the vehicle 10. The speed signal is compared at step 154 with the criterion for this sensor, which, in this case, is a threshold speed. The threshold speed may be a fixed threshold of the upper speed limit of the country in which the vehicle 10 is used. Alternatively, the threshold speed may be dictated by the satellite navigation system 34, being the speed limit on the road on which the vehicle 10 is travelling.

At step 156, the criterion is deemed to be met if the comparison shows that the signal received from the sensor indicates that the instantaneous speed of the vehicle 10 is above the threshold.

If the criterion is met 158 then an output signal is generated at step 160. If the criterion is not met 162, the process returns to the first step 152 and continues monitoring the input signals received from the sensor. It is envisaged that in some embodiments the user may specify whether or not an output signal is required when a criterion is met by a selection made at the HMI 20 when setting up the system 14.

In the case that an output signal is generated 160, the processor 30 renders an electrical output signal, in dependence on the input signal, the criterion that is met, and the sensor from which the input signal has been received. For example, the processor 30 may render an output signal that, when converted to an audio signal, is a beeping sound to indicate excessive speed.

Where the sensor is an indicator sensor, the input signal contains information as to whether either of the left or right indicator switches has been operated or not. If one of the indicator switches has been operated, the criterion at step 156 is met 158. The sensor may not continually send information to the on-board computer 18, but rather only send a signal if the indicator is on. In the event that an indicator signal is detected (i.e. the criterion is met) 158, the output signal generated at step 160 may be a familiar ticking sound of an operative indicator.

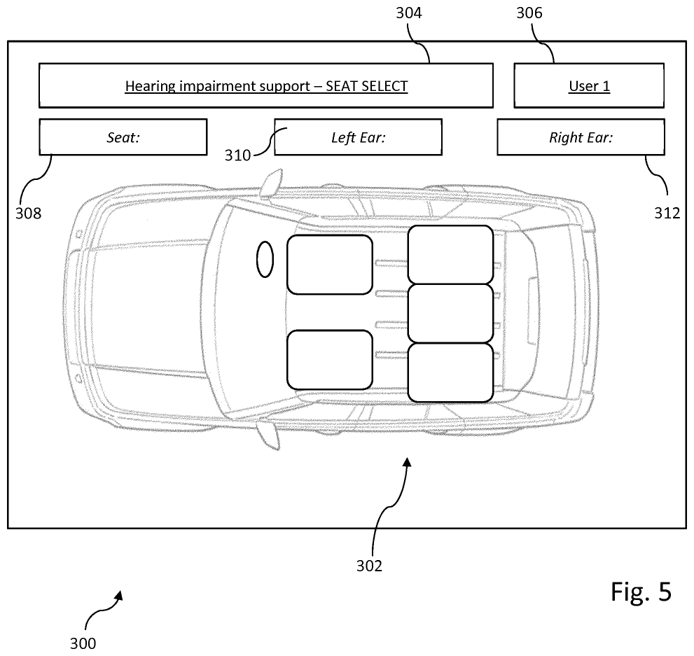

The processor 30 designates 164 the relevant output locations for the output signal to be sent to according to user settings that have been specified. The specification of user settings will be considered below in relation to FIGS. 5 to 7. The output locations may comprise any combination of output hardware 24 including the hearing assistance device or a plurality of hearing assistance devices 88, and/or the loudspeakers 40. When multiple output signals are to be sent to an output location such as the output hardware 24, the process would include a step (not shown) whereby the signals are mixed accordingly, or certain signals may be delayed for maximum impact.

The output signal is amplified 166 at the amplifier 38, before being transmitted 168 to the relevant output locations by the exchange module 26. Transmission 168 of an output signal to the hearing assistance device(s) 88 and/or the loudspeakers 40 will result in the conversion of the output signal to an audio alert. Optionally, an audio alert output signal is transmitted to a hearing assistance device 88 while the ambient noise audio signal from the microphones 76 is used to create a signal that is the inverse of the ambient noise at the loudspeakers 40 in order to attenuate noise within the interior 12 by the mechanism of destructive interference. This further aids the user in hearing the signal clearly by improving the signal to noise ratio.

In some embodiments, the system 14 may also transmit 168 information from the infotainment system 33 and/or the satellite navigation system 34 directly to a user's hearing assistance device 88. In some embodiments, sound registered by the microphones 76 within the interior of the vehicle 10 can be used to aid the user in hearing other users. The system may identify the position of a speaker by a threshold comparison of all microphones and amplify the audio signal input from the microphone having the highest signal input. The input from the microphone would then be sent to the hearing assistance device, or may be processed to filter out unwanted noise first. As will be discussed in more detail with relation to FIG. 5, by specifying a zone in which they are seated, which may comprise their seating position, the hearing impaired user can tailor the system 14 to amplify ambient sound from all other locations in the vehicle 10, or from specific locations. It is also possible to amplify the voice of a speaker other than the user through the headrest arrays 102 of the user's seat to improve the signal-to-noise ratio within the vehicle 10.

FIG. 4 shows a start-up process 200 of the system 14. It is envisaged that the process 200 of FIG. 4 will take place immediately upon activation of the vehicle 10 (i.e. the engine is turned on), although it would also be possible for the process 200 to be implemented when the vehicle 10 has not been activated. For example, the system 14 may implement the process 200 when a user is detected in the interior 12 of the vehicle 10.

At a first step 202 of the process 200 of FIG. 4, the system 14 determines whether a user within the interior 12 of the vehicle 10 is wearing a wireless-enabled hearing assistance device 88. The exchange module 26 is configured to search for and detect hearing assistance devices 88, and upon detection of the hearing assistance devices 88, communicates the information about the detected devices 88 to the on-board computer 18. For example, Bluetooth enabled devices 88 have a default or user-chosen identifier associated with them, which can be displayed to the user to help with selection of the correct device 88.

Upon detection 204 of a hearing assistance device 88 and communication of the associated information, the on-board computer 18 determines 206 whether the hearing assistance device 88 has been connected with the hearing assistance system 14 before. This determination is made by comparison of the information received concerning the device 88 with information stored within the data storage memory 36 where a record of the device history is stored. If it is determined that the hearing assistance device 88 has been identified and connected previously 208, the exchange module 26 connects 210 automatically to the hearing assistance device 88 and the processor 30 implements 212 associated user settings that were specified when the device 88 was connected before.

If it is determined 206 that the detected hearing assistance device 88 has not been connected before 214, the system 14 invites 216 the user to connect or ‘pair’ the detected hearing assistance device 88 to the hearing assistance system 14. In this case, following connection 218 of the hearing assistance device 88 to the system 14, the system 14 invites 220 users to specify their preferred accessibility settings. This is performed via the HMI 20 and will be discussed in more detail later when considering FIGS. 5 to 7. Following specification of the user's preferred settings, the settings are implemented 212.

If, at the first step 202 of the process 200 of FIG. 4, no hearing assistance device 88 is detected 222 within a predetermined time period, 10 seconds for example, the processor 30 instructs the exchange module 26 to cease searching for hearing assistance devices 88 and determines 224 whether any settings have been specified before by comparison with the data storage memory 36. These are specifically settings where no hearing assistance device 88 is present. If settings have been specified before 226, the system 14 implements these settings 212. If no settings are found 228, the user is invited 220 to specify their preferred accessibility settings, preferences or characteristics via the HMI 20. The system 14 may also communicate to the user that a Bluetooth device 88 has not been found and/or a connection has not been established (if the data storage memory 36 contains information relating to a hearing assistance device 88), and subsequently prompt the user to enable Bluetooth and restart the process if they wish to connect a hearing assistance device 88 to the system 14. The user settings are implemented 212 if the user consequently sets new accessibility settings for the system 14.

It is envisaged that step 224 and step 202 may be implemented simultaneously. For example, if accessibility settings have been previously specified 226 and do not require a hearing assistance device 88 connection, then the process may implement 212 these settings immediately. If, following the implementation 212 of these settings, a hearing assistance device 88 is detected 204, the system 14 may communicate to the user via the HMI 20 that a hearing assistance device 88 has been detected and that the user should provide guidance on how the system 14 should proceed.

Alternatively, the system 14 may implement a ranking system to allow the user to rank configurations of the system 14 in order of preference. A configuration comprises information regarding the number of connections to hearing assistance devices 88, and which devices 88 to connect to, and information regarding groups of user settings. Groups of user settings may include which alert signals to send directly to the hearing assistance devices 88, and/or the level of reinforcement to be provided by the loudspeakers 40.

For example, the user may alter the rankings of the configurations so that upon activation, the system 14 firstly attempts to operate according to a first configuration, whereby the system 14 connects to two previously identified hearing assistance devices 88 and implements a first group of settings. If the first configuration cannot be achieved, the system 14 would then attempt to operate according to a second configuration, in which the system 14 connects to only one previously identified hearing assistance device 88 and implements a second group of settings. In the event that the system 14 cannot operate according to the first and second configurations, a third configuration would be operated. It is envisaged that the final configuration would be that the system 14 implements a third group of settings as no hearing assistance devices 88 are detected. By operating the system 14 using rankings, if the user is not using or wearing one or both of their hearing assistance devices 88 when using the vehicle 10, the system 14 automatically defaults to the first implementable group of settings.

FIGS. 5 to 7 illustrate an example of how the specification of preferred user characteristics, preferences or settings at step 220 of FIG. 4 may be realised on a touch-sensitive HMI 20. FIGS. 5 to 7 show consecutive screen arrangements 300, 400, 500 where the user is prompted to make selections to tailor the system 14 to their needs. It will be assumed here that one hearing assistance device 88 has been identified in the vehicle 10 by the activation process, that the one hearing assistance device 88 had not been previously connected with the system 14, and that the user has already connected the hearing assistance device 88 with the system 14 following invitation to do so at step 216.

FIG. 5 illustrates an HMI screen 300 whereby the hearing impaired user is prompted to select a zone on a representation 302 of the vehicle 10. The zone may correspond, for example, to the user's seating position within the vehicle. All screens in FIGS. 5 to 7 include a title portion 304, a user identifier 306, and three selection portions 308, 310, 312 that outline the selections made on previous screens as the user moves through the setup process. The selection positions in FIGS. 5 to 7 include the zone selection portion 308, the left ear selection portion 310, and the right ear selection portion 312, although many other selections may also be indicated here.

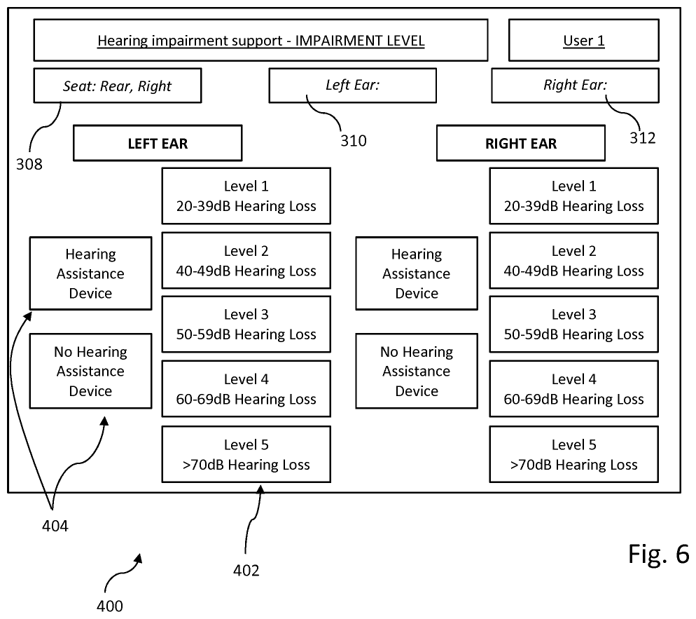

Once the user has used the input interface 46 of the HMI 20 to select their zone, the HMI 20 displays the second screen 400 shown in FIG. 6 which relates to the level of hearing impairment of the user. It will be noticed that the zone selection portion 308 has been updated, here identifying that the rear-right zone has been selected.

In FIG. 6, a screen 400 is presented to the user in which they are asked to specify the level of hearing impairment for each ear using a list 402 of predetermined hearing loss intervals measured in decibels (dB). It is expected that a user will know their hearing loss level, having been diagnosed appropriately. If the user is hearing impaired in one ear only, it is possible to not select a level of hearing loss for a particular ear. The system 14 would then default to settings for no hearing loss and no hearing assistance device 88 for that ear.

The user is also asked to specify with which ear their hearing assistance device 88 is used by selecting the correct option using selection boxes 404 shown to the left of each level list 402. As the case being considered is where the system 14 has been identified and has been connected to a single hearing assistance device 88 only, if the user selects that they use a hearing assistance device 88 in their left ear, then the system 14 will assume a default setting of no right ear hearing assistance device 88, unless otherwise indicated. If the user selects the hearing assistance device option for both ears to indicate that they use a hearing assistance device 88 in each ear, then the system 14 would communicate to the user that only a single hearing assistance device 88 has been connected to the system 14.

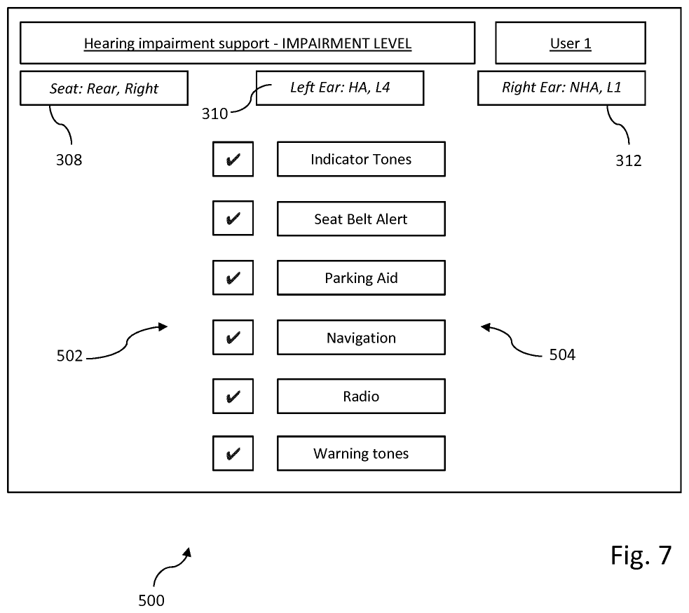

Following selection of the appropriate options in the screen 400 of FIG. 6, the HMI 20 displays the screen 500 of FIG. 7. The left ear selection portion 310 and right ear selection portion 312 have been updated to reflect the options chosen by the user at the screen 400 of FIG. 6. The user has indicated that their hearing assistance device 88 is worn in their left ear and that their hearing loss in that ear is at level 4 (60-69 dB hearing loss). The user has specified that they do not wear a hearing assistance device 88 in their right ear, and has a hearing loss of between 20 dB and 39 dB, level 1.

At the screen 500 of FIG. 7, the user is asked to select 502 which audio alerts or other sounds 504 they wish to hear through their hearing assistance device 88 during vehicle operation. This is by no means an exhaustive list of the potential alert audio that may be routed to the hearing assistance device 88, and the system 14 can be configured to transmit many different vehicle audio alerts to a connected hearing assistance device 88.

It should be noted that the HMI screen configurations 300, 400, 500 of FIGS. 5 to 7 are by no means a complete set but are just illustrative of how the implementation of settings may be achieved. Many other screen configurations are possible, and the settings that may be implemented vary highly. For example, the system 14 may be highly automated, with the user only required to choose their seating position or zone and their level of hearing impairment. The system 14 would then implement appropriate settings without any further user input.

In some embodiments, the user may choose to have their hearing tested by the vehicle 10 to ascertain a correct level selection. For example, in some embodiments, a user may instruct the hearing assistance system 14 via the HMI 20 to conduct an audiometric test. During the audiometric test the hearing assistance system 14 outputs a plurality of audible sounds having different frequencies and/or volume levels. The user listens to the plurality of audible sounds and responds to each via the HMI 20 to indicate how well they have heard each sound. In this manner an audiogram may be generated for each of the user's ears. The audiogram is indicative of the user's hearing acuity and/or impairment (specific to a particular ear) and is used by the hearing assistance system 14 to derive the user characteristics or settings to be implemented 212.

In a further embodiment, the hearing assistance system 14 may conduct a covert audiometric test. During such a covert audiometric test the hearing assistance system 14 outputs a plurality of audible commands at differing frequencies and/or volume levels in which the user is requested to operate a vehicle system. For example, the system 14 may request that the user change a vehicle setting, e.g. open/close a window, change a radio station, operate a heating or ventilation control etc. The hearing assistance system 14 monitors the vehicle systems for changes therein elicited by the audible command. If there is a correlation between the audible command and a change in a vehicle system then the hearing assistance system 14 makes a determination that the user has heard the audible command and responded thereto. If there is no change in a vehicle system in response to an audible commend then the hearing assistance system determines that the user has not heard the audible command and infers a hearing impairment in relation to the given frequency and/or volume level at which the audible command was output. In this manner an audiogram may be generated for each of the user's ears. The audiogram is indicative of the user's hearing acuity and or impairment (specific to a particular ear) and is used by the system 14 to derive the user characteristics or settings to be implemented 212.

An additional or alternative hearing test may be performed for users wearing a hearing assistance device such as a hearing aid or headphones. In this embodiment a microphone is provided within the hearing assistance device to enable otoacoustic emission tracking (OAE). By way of explanation, when sound waves hit the eardrum, causing the bones of the middle ear to send signals to the cochlea, the vibrations create faint, low-intensity sounds that are sent back out through the ear canal.

In this embodiment a plurality of audible sounds having different frequencies and/or volume levels are output to the user's ear from the hearing assistance device. The microphone within the hearing assistance device measures each of the plurality of audible sounds entering and returning from the ear and the hearing assistance device (optionally in combination with the hearing assistance system 14) determines how well each of the plurality of audible sounds was actually heard. In this manner an audiogram may be generated for each of the user's ears. The audiogram is indicative of the user's hearing acuity and/or impairment (specific to a particular ear) and is used by the hearing assistance system 14 to derive the user characteristics or settings to be implemented 212.

In other embodiments, the user may be asked to specify other users in the vehicle 10 and their level of hearing impairment, the system 14 then tailoring the settings within the interior 12 of the vehicle 10 to multiple users. In doing this, the system 14 will therefore be able to transmit differently tailored alerts and combinations of information to each individual hearing impaired user (who may or may not be using hearing assistance devices 88), or to users who do not have a hearing impairment.

In other embodiments, other screens may be incorporated into the user set-up procedure whereby the user is asked to select which alerts should be sent to the loudspeakers 40.

Examples of alerts or other sounds that may be transmitted to hearing assistance devices 88 or reinforced through the loudspeakers 40 by the system 14 are: indicator tones; seat belt warnings; parking aid tones to indicate the proximity of the vehicle 10 to exterior objects; instructions from the satellite navigation system 34; signals from the infotainment system 33 such as music or radio; operational vehicle tones for alerting the user to a particular fault within the engine; phone alerts and phone conversations; conversational assist, where the system 14 uses the microphones 76, a seat identification system (not shown) and beamforming techniques to identify a zone corresponding to a microphone 76 or microphones 76 in which a speaking occupant is positioned and to reduce ambient noise and increase the volume level of the speaking occupant's speech; confirmation tones to alert the user that a certain setting has been activated; text narration; low fuel warnings; and low charge warnings for electric vehicles.

The system 14 may also continue to be connected to the user's hearing assistance device 88 after the user has exited the vehicle 10 up to a certain time limit or distance from the vehicle 10. If the user walks 20m away from the vehicle 10, for example, the system 14 may disconnect from the hearing assistance device 88. By doing this, the system 14 is therefore able to continue to provide audio alerts to the user, such as that the vehicle 10 has been locked, that the lights have been left on, or that the alarm is sounding.

Additionally, operative noises made by the vehicle 10 may be transmitted to the user's hearing assistance device 88 or sounded through the loudspeakers 40 to aid in the user's hearing of these sounds. For example, a digital reproduction of the engine noise may be transmitted to the hearing assistance device 88 to aid the user in operation of the vehicle 10 and to prevent the user from over-revving the engine or to prevent stalling. Not only does this improve the driving experience, but also improves the driving skill of the user.

The user may connect a hearing assistance device 88 to the exchange module 26 via a mobile device such as a mobile phone. Optionally, the mobile phone may then be used in place of the HMI 20.

Alternatively, the system 14 may include variable audio alerts. The audio alerts may vary in volume, by altering the amplitude of the output signal or may vary in the sound that is heard by the user by altering the waveform of the output signal. An example of this is that a user may request that the alerts are spoken so that the reason for the alert is immediately obvious. This is made possible because the alert is transmitted directly to the hearing assistance device 88 of the user, ensuring that losses between the system 14 and the user are minimised.

Furthermore, the system 14 may be varied to further aid the user in hearing the alert. Some users do not have broadband impairment, but may have hearing loss that is particularly prevalent at certain frequencies or across frequency bands. Therefore, the user may not ordinarily be able to hear the alert as its audio component is in a band that is inaudible to the user. Even if this alert is then transmitted to a hearing assistance device 88, the user may not hear the alert clearly. Therefore, the system 14 is able to vary the frequency content or individual frequency components of the audio alerts to aid the user further. The user would have to specify this during the settings selection process.

In an alternative embodiment, the vehicle is operable in an autonomous mode, and therefore comprises an autonomous driving control module that controls the vehicle during the autonomous mode. When the vehicle is operating in the autonomous mode, it may be necessary for the autonomous driving control module to request that the user retakes control of the vehicle. This may occur, for example, so that the user can guide the vehicle into and out of motorway driving or when an emergency vehicle is detected. Alternatively, a request for user input may occur following a malfunction of a vehicle component that is necessary for the operation of the vehicle in the autonomous mode. In this case, it is necessary for the system to be able to communicate the request to the user, and so electrical output signals may be generated and communicated to the user's hearing assistance device in accordance with the request from the autonomous driving control module.

Many modifications may be made to the above examples without departing from the scope of the invention as defined in the accompanying claims.

1. A system for a vehicle for providing improved audio for a hearing impaired user, the system comprising:
an input configured to receive electrical input signals from at least one vehicle mounted device, wherein the electrical input signals are representative of an operative state of the vehicle; and
a processor configured to compare the electrical input signals with a predefined criterion to determine a comparison; the system being configured to generate electrical output signals corresponding to audio based on the comparison and to transmit the electrical output signals to an audio output device for outputting the audio to the user, wherein the electrical input signals include electric signals received from a sensor system configured to indicate a vehicle operation, a vehicle status, a vehicle system malfunction, and a vehicle component malfunction, and wherein the processor is configured to perform one of more of the following:
comparing the electrical input signals received from a sensor measuring vehicle speed with a predetermined criterion in the form of a predetermined speed threshold, and generating the electrical output signals based on the predetermined speed threshold being exceeded;
comparing the electrical input signals received from a fuel level sensor with a predetermined threshold fuel level regarded as a minimum acceptable fuel level, and generating the electrical output signals in dependence on the fuel level falling below the predetermined threshold fuel level;
comparing the electrical input signals received from a charge sensor associated with a rechargeable electrical storage system with a predetermined threshold charge level regarded as a minimum acceptable charge level, and generating the electrical output signals based on the charge level falling below the predetermined threshold charge level;
comparing the electrical signals with a criterion to indicate that a direction indicator is on and, if it is determined that the indicator is on based on the comparison, generating the electrical output signals; and
wherein the vehicle is operable in an autonomous mode, comparing the electrical signals with a criterion to indicate malfunction of a component related to the autonomous mode and, if it is determined that the component has malfunctioned based on the comparison, generating the electrical output signals.

2. The system as claimed in claim 1, further comprising an exchange module configured to transmit the electrical output signals to the audio output device.

3. The system as claimed in claim 2, wherein the exchange module is wireless enabled to permit wireless communication with the audio output device.

4. The system as claimed in claim 2, wherein the processor is further configured to communicate with the exchange module.

5. The system as claimed in claim 4, wherein the exchange module is in electrical communication with the processor by way of an amplifier.

6. The system as claimed in claim 1, wherein the audio output device comprises a hearing assistance device.

7. (canceled)

8. (canceled)

9. (canceled)

10. (canceled)

11. (canceled)

12. (canceled)

13. The system as claimed in claim 1, wherein the vehicle mounted device comprises a microphone.

14. The system as claimed in claim 1, comprising a further input to receive an occupancy signal to indicate that the user is external to the vehicle, the system being further configured to generate an electrical output signal based on the occupancy signal.

15. The system as claimed in claim 14, wherein the system is further configured to determine a distance of the user from the vehicle and generate an electrical output signal based on the distance being less than a predetermined distance from the vehicle.

16. A system for a vehicle comprising a zone and a microphone associated with the zone, the system being configured to provide improved audio for a hearing impaired user of the vehicle, the system comprising:
a first input configured to receive electrical input signals from the microphone corresponding to sound within the zone; and
a second input configured to receive a signal indicative of an occupant being within the zone;
the system being further configured to generate electrical output signals corresponding to the electrical input signals received from the microphone and to transmit the electrical output signals to an audio output device for outputting audio to the user based on the second input.

17. The system as claimed in claim 16, further comprising a user input module configured to enable selection of the zone by the user to identify the presence of an occupant within the zone for input to the second input.

18. The system as claimed in claim 16, further comprising a seat identification system for identifying the presence of an occupant within the zone automatically for input to the second input.

19. (canceled)

20. (canceled)

21. (canceled)

22. (canceled)

23. A vehicle comprising the system as claimed in claim 1.

24. The vehicle as claimed in claim 23, further comprising at least one loudspeaker and at least one seat having a head rest, said at least one loudspeaker being arranged within the head rest of the at least one seat and wherein the system is configured to transmit electrical output signals to said at least one loudspeaker.

25. The vehicle as claimed in claim 23, wherein the vehicle comprises an autonomous driving control module, and the system is further configured to generate electrical output signals based on a manual operation request from the autonomous driving control module.

26. A processor for use in the system as claimed in claim 1.

27. A method of providing improved audio for a hearing impaired user in a vehicle, the method comprising:
receiving electrical input signals from at least one vehicle mounted device, wherein the electrical input signals are representative of an operative state of the vehicle, said electrical input signals including electric signals received from a sensor system configured to indicate a vehicle operation, a vehicle status, a vehicle system malfunction, and a vehicle component malfunction;
comparing the electrical input signals with a predefined criterion to determine a comparison;
generating electrical output signals corresponding to audio based on the comparison;
transmitting the electrical output signals to an audio output device for outputting the audio to the user, and one of the following:
comparing the electrical input signals received from a sensor measuring vehicle speed with a predetermined criterion in the form of a predetermined speed threshold, and generating the electrical output signals based on the predetermined speed threshold being exceeded;
comparing the electrical input signals received from a fuel level sensor with a predetermined threshold fuel level regarded as a minimum acceptable fuel level, and generating the electrical output signals based on the fuel level falling below the predetermined threshold fuel level;
comparing the electrical input signals received from a charge sensor associated with a rechargeable electrical storage system with a predetermined threshold charge level regarded as a minimum acceptable charge level, and generating the electrical output signals based on the charge level falling below the predetermined threshold charge level;
comparing the electrical signals with a criterion to indicate that a direction indicator is on and, if it is determined that the indicator is on based on the comparison, generating the electrical output signals; and
wherein the vehicle is operable in an autonomous mode, comparing the electrical signals with a criterion to indicate malfunction of a component related to the autonomous mode and, if it is determined that the component has malfunctioned based on the comparison, generating the electrical output signals.

28. (canceled)

29. A non-transitory computer readable media device storing computer program code adapted, when executed by a processor, to cause the processor to perform the method of claim 27.

30. (canceled)

31.-51 (canceled)
